(19) United States
(12) Patent Application Publication
(10) Pub. No.: US 2026/0162521 A1
(43) Pub. Date: Jun. 11, 2026

(54) METHOD, COMPUTING UNIT AND COMPUTER PROGRAM

(71) Applicant: Robert Bosch GmbH, Stuttgart (DE)

(72) Inventors: Jan Karl Warzelhan, Bockhorn (DE); Frank Rottmann, Muenchen (DE); Petra Oster, Muenchen (DE)

(21) Appl. No.: 19/099,327

(22) PCT Filed: Jul. 26, 2023
(86) PCT No.: PCT/EP2023/070734

§ 371 Date: Jan. 28, 2025

(30) Foreign Application Priority Data
Aug. 2, 2022 (DE) 10 2022 207 966.3

(51) Int. Cl. G08B 29/18; G08B 25/00

(52) U.S. Cl. CPC G08B 29/186; G08B 25/001

(57) ABSTRACT

The invention relates to a method comprising obtaining (201) a quantity of alarm events from a monitoring device (2), determine (202) an alarm event value for the alarm event from the quantity of alarm events by a method based on machine learning, selecting (203) an alarm event from the quantity of alarm events based at least on the alarm event value; receiving (206) at least one piece of information about the selected alarm event; and adjusting (207) the method based on machine learning using the received information.

### BACKGROUND

The present invention relates to a method, as well as a computing unit and a computer program for carrying it out.

Monitoring of monitoring areas, for example buildings and/or outdoor spaces, is often carried out by means of sensors and/or video cameras. The video cameras and/or the sensors provide monitoring material, which is frequently used by security personnel in central control centers or Security Operations Centers (SOCs).

In this regard, DE 10 2016 222 134 A1 describes a video analysis device for a monitoring device for monitoring a monitoring area, wherein the monitoring device comprises at least one video camera, wherein the video camera is arranged in the monitoring area for monitoring a portion of the monitoring area, wherein the video camera provides video data and metadata.

### SUMMARY

According to the invention, a method, in particular for selecting an alarm event from a quantity of alarm events and/or for adjusting the method based on machine learning, as well as a computing unit and a computer program for carrying out the same, are proposed with the features of the independent claims. Advantageous embodiments are the subject of the dependent claims and the following description.

The background to the invention is the following finding: Video monitoring cameras can be configured to trigger alarms, for instance in devices used to protect a facility, when movement by intruders within a restricted area is visible on the screen. These alarms are then forwarded to security personnel or Security Operations Centers for further action. However, most of these alarms (up to 90%) are so-called “false alarms” caused by non-critical faults or, for example, poor weather conditions or other natural disruptions in the surrounding environment. Typically, the user needs to review, evaluate, comment on each of these detected alarms and document the actions taken when an alarm occurs so that the inspection tracking is updated and the actions taken are documented in a security protocol. However, it is noted that not all alarms are always documented in the security protocol along with a comment on the situation that triggered the alarm. This may be because that a location is deactivated, for example, in bad weather (e.g. during a thunderstorm), which typically leads to many false alarms in a video analysis device, so that all alarms are simply suppressed (i.e. do not appear in the list), or it may be because not every consecutive alarm is commented upon, or it may be because the user was too busy and commented on only some of the alarms (according to the user's discretion regarding which alarms need to be documented).

The invention presents a way to improve the overall performance of the system and to significantly reduce the number of false alarms, in that an analysis process based on machine learning only selects certain alarm events for information input by the user (user review, commentary, or classification), in particular those with a detection or classification result that is not unambiguous, e.g. in the form of an alarm event value that lies outside of one or more defined unambiguous ranges.

Information about a selected alarm event can then be entered by a user, such as a safety officer, particularly by flagging, falsifying, or annotating it, for example. The remarks entered by the user on these alarms may be referred to as “Ground Truth” (GT) (true designation of the actual situation that triggered the alarm) and may then be used to re-train and adjust the method or model based on machine learning, and/or to update the parameters of the system to improve the overall performance of the system.

The invention leads away from a pure user decision as to which alarm events are to be reviewed, towards an automated decision. This, in particular, solves the problem that the user typically does not know what alarm events are important for the underlying model in order to measure and improve performance based on true flagging.

By improving the security protocol over time, the number of potential false alarms is optimized for the user, giving them more time to, for example, only detect and respond to the relevant safety issues and incidents at the property while significantly improving system performance.

Security protocols are a common method of reporting and documenting incidents in SOCs. Using this approach, alarm events can be displayed to the user (e.g., in a table/list view). It may be contemplated that by clicking on such an event, the alarm event with the associated video clips and/or a summary image (best shot) will be displayed to the user to expedite the validation process. After validating the alarm event and evaluating the alarm event either as a true alarm (to take further action) or as a false alarm (suppressing/discarding the alarm event) in the event of faults or identified non-critical activities, the user can complete the investigation of the alarm event and turn to the next alarm event.

In one embodiment, the invention improves such a process in that it is provided that a user dialog is displayed, which in particular asks the user to review the alarm event and to provide information or give feedback. This display or request is generated dynamically, i.e. the user dialog does not appear for every alarm event, but only for the selected ones.

In one configuration, an alarm event is selected from the quantity of alarm events furthermore based on at least one criterion, selected from:
the type of alarm event (burglary alarm, loitering alarm, object in range, . . . ) ,
the time at which the user investigated the alarm event, i.e., the time of a review of the alarm event,
the time at which the alarm event occurred (e.g., during the night),
the number of additional alarm events that occurred in a given period of time (e.g., a few seconds to a few minutes) around the alarm event,
the measured image/video quality,
the review time the user spent viewing the videos.

In one configuration, the user dialog for receiving information for the selected alarm event is displayed based on a time that has elapsed since the last time the user dialog was displayed for receiving the information for a (different) selected alarm event. In other words, the user is not prompted to conduct a review more often than once in a given period of time to avoid frustration or to avoid interfering with the user's daily routine.

In one configuration, an alarm event continues to be selected from the quantity of alarm events based on the number of alarm events displayed. For example, if there are not many alarm events and the workload is low for the user, the user may spend more time responding than in a hectic situation where the additional time needed to flag alarm events and the user's workload should be minimized.

In one embodiment, the user dialog for receiving the information is displayed in response to a user input. In other words, the user is able to provide feedback at any time. Even if the machine learning-based method did not select the alarm event, the user is still free to do so. That is, the user may provide information on a current alarm event at any time.

In one embodiment, the user dialog comprises a quantity of predetermined information that is selectable by the user. In order to ensure seamless and intuitive use for the user, it is advantageous if the user has to enter as little information as possible, and instead can select from pre-determined general tags, e.g. “rain”, “snow”, “animal”, “dog”, “cat”, “bird”, “insect”, “spider”, “spiderweb”, “wind”, “light” etc. It may be provided that new predetermined selectable information can also be generated from entered information.

In one configuration, the user dialog comprises a quantity of predetermined information selectable by the user depending on the time. In particular, lighting conditions, and thus also the lights and shadows visible in the image, are dependent on the time of day.

A computing unit according to the invention, e.g., a control device of a video analysis device, is configured, in particular in terms of programming, to carry out a method according to the invention.

The implementation of a method according to the invention in the form of a computer program or computer program product comprising program code for carrying out all method steps is advantageous as well, because the associated costs are very low, in particular if an executing control device is also used for other tasks and is therefore already available. Lastly, a machine-readable storage medium is provided, on which a computer program as described above is stored. Suitable storage media or data carriers for providing the computer program are in particular magnetic, optical and electrical memories, such as hard drives, flash memories, EEPROMs, DVDs, etc. Downloading a program via computer networks (Internet, intranet, etc.) is possible, too. Such a download can be wired or cabled or wireless (e.g., via a WLAN, a 3G, 4G, 5G, or 6G connection, etc.).

### BRIEF DESCRIPTION OF THE DRAWINGS

Further advantages and embodiments of the invention will emerge from the description and the accompanying drawing.

The invention is illustrated schematically in the drawing on the basis of exemplary embodiments and is described in the following with reference to said drawing.

FIG. 1 shows a diagram of a video analysis device in a configuration which could serve as the basis for the invention.

FIG. 2 shows an exemplary implementation of an embodiment for selecting an alarm event from a quantity of alarm events.

### DETAILED DESCRIPTION

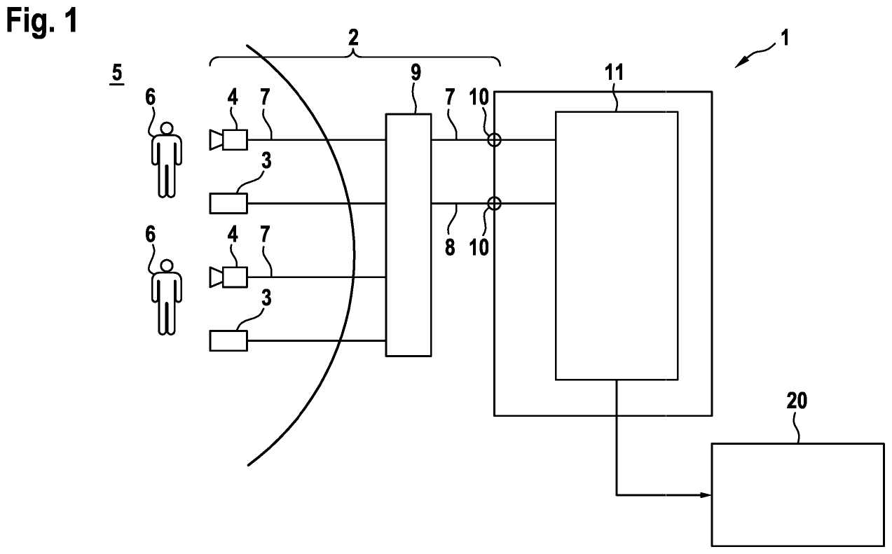

FIG. 1 shows a video analysis device 1 for a monitoring device 2. The monitoring device comprises a plurality of sensors 3 and a plurality of video cameras 4. The sensors 3 are, for example, fire detectors, thermal sensors, motion detectors, chip card readers, or other sensors. The video cameras 4 are in particular color video cameras and are configured as CCD or CMOS cameras, for example. The video cameras 4 and/or the sensors 3 are arranged in a monitoring area 5, wherein the sensors 3 and/or video cameras 4 are arranged in a regular fashion in the monitoring area 5; alternatively and/or in addition, the video cameras 4 and the sensors 3 are arranged in an irregular fashion in the monitoring area 5. The video cameras 4 and the sensors 3 are configured to monitor the monitoring area 5 visually and/or via sensors. The video cameras 4 and/or the sensors 3 each monitor a portion of the monitoring area 5, wherein the portions recorded and/or monitored by the individual video cameras 4 and/or sensors 3 are preferably overlapping such that the entire monitoring area 5 can be monitored visually and/or via sensors. Real objects 6 are arranged in the monitoring area 5, wherein the real objects 6 are, for example, people, animals and/or things. In particular, the real objects in the monitoring area are variable so that the position and/or properties of the real objects 6 can change over time. The change in the position and/or properties of the real objects 6 corresponds in particular to an alarm event in the monitoring area 5.

For example, one sensor 3 is configured as a motion sensor so that a motion sensor 3 can display and/or record the movement of the real object 6 in the monitoring area 5. The video cameras 4 provide video data 7 and the sensors 3 provide sensor data.

The monitoring device 2 comprises a data generation unit 9, wherein the data generation unit 9 is configured to provide video data 7 and metadata 8 based on the video data 7 and/or sensor data from the video analysis device 1. The metadata 8 comprises, in particular, information relating to the real objects 6 in the monitoring area 5, for example their position, their size, and/or further information. The video data comprises, in particular, video images of the section of the monitoring area 5 of one and/or the video cameras 4 in the monitoring area 2.

Here, the video analysis device 1 comprises two input interfaces 10, wherein the input interfaces 10 are connected to the monitoring device 2 via data technology, wherein the input interfaces 10 are configured to take over the video data 7 and the metadata 8.

The video analysis device 1 comprises a central process module 11. In particular, the central process module 11 is configured as a central processor unit, for example as a microprocessor. The central process module 11 is in particular supplied with the metadata 8 and the video data 7.

The process module 11 is configured to evaluate video data 7 based on the metadata 8 and the video data 7, in particular to determine an alarm event value for each alarm event. To this end, a method based on machine learning is implemented in process module 11, which functions as a false alarm classification system, i.e. which classifies the alarm events as a true alarm or a false alarm.

In this respect, all machine learning methods that enable classification are generally conceivable. In particular, all different types of neural networks may be utilized. Supervised learning can be used as a method in this respect. Supervised learning means that a user reviews and, if necessary, corrects the classification result to improve the false alarm classification system.

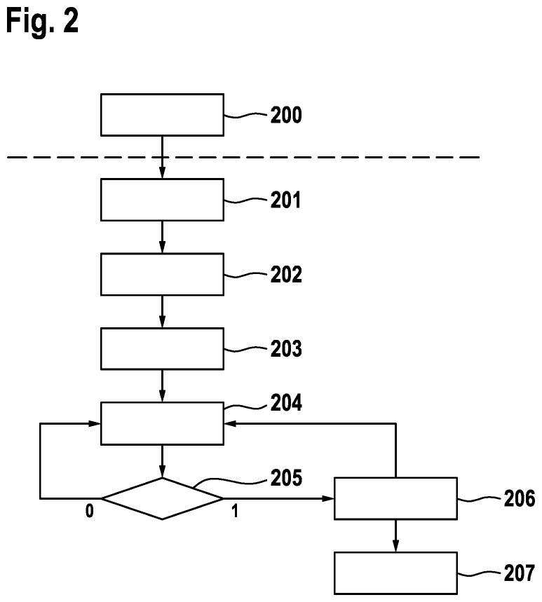

An example process for a configuration of the method is explained below with reference to FIGS. 1 and 2.

The method may begin with an optional step 200, which comprises a learning or training mode. In such a training mode, all alarm events received from monitoring device 2 are displayed to a user, for example, on a display means or a human machine interface (HMI) 20. In particular, no alarm event display is suppressed, not even the displaying of alarms that are potentially false alarms. In this training mode, a user dialog is displayed for each alarm event to receive information, particularly including a classification of the selected alarm event as alarm or false alarm. Based on these classifications, the system can in particular “learn” which display criterion, e.g. a range of values, an alarm event value must match in order to be a true alarm with certainty, and which suppression criterion, e.g. a range of values, an alarm event value must match in order to be a false alarm with certainty. The system may run in this mode for some time (depending on the number of alarm events) until sufficient feedback has been collected and the false alarm classification system has been taught sufficiently.

In the case of supervised learning, it is necessary to provide labeled training data which is already assigned to one of the predetermined classes. Various options are possible for this purpose. In addition to the manual labeling of training data (entering information) described herein, for example, in which a user respectively indicates whether an alarm is a true alarm or false alarm, a partially automated or automated labeling process can alternatively or additionally be used. For example, a larger data set can be labeled automatically based on a small labeled data set; optionally, this semi-automated labelling can then be checked manually.

In a next step 201, the video analysis device 1 then switches to the regular operating mode. In this regular operating mode, the video analysis device 1 receives a quantity of alarm events, in the described example, from the monitoring device 2. This obtaining can occur in real-time, e.g., any time a movement is detected, or based on a recorded memory.

In a subsequent step 202, an alarm event value is determined for each of the alarm events using the method based on machine learning. In a step 203, all alarm events with an alarm event value corresponding to the display criterion are displayed and the display of all alarm events with an alarm event value corresponding to a suppression criterion is suppressed. As a result of the previously conducted learning process, a plurality of alarm events can thus be attributed to the two classes. Further, one or more alarm events are selected from the quantity of alarm events based at least on the alarm event value, in particular for a user review, and also displayed.

In one embodiment, in particular, the alarm events at the boundary between the suppression criterion and the display criterion, or if such a boundary does not exist, alarm events that do not satisfy the suppression criterion or the display criterion (unambiguously) are selected.

It is also possible to measure the distance in the feature space of the extracted features of the false alarm classification system to decide which alarm events should be reviewed and commented on. This helps to ensure that the flags cover the entire feature space as well as possible.

The displayed alarm events are viewed in a step 204 by a user, in particular in a known manner on a display means, such as a monitor.

In a step 205, it is determined whether the alarm event currently being viewed belongs to the alarm events selected in step 203. If not, branch 0, the user may view further alarm events, step 204. If so, branch 1, the user, particularly at the end of the review, which can be determined by clicking on a corresponding button, for example, is prompted in a step 206, to review this alarm event via a user dialog, for example, and in particular to enter information, particularly comprising a classification as either a true alarm or a false alarm.

The time spent by the user in reviewing the alarm event can be used to distinguish alarms that are difficult for the user and take a lot of time. These are important alarms that should be commented on and used to improve the underlying classification system. Either they are false alarms, meaning that the system should suppress them (if the system is not in training mode) and the user need not review them, or they are real alarms, in which case the user must be instructed on what is going on in the scene, for example by seeing where the activity is taking place.

If the user plays a video associated with the alarm event multiple times and zooms into the video material, this may also indicate that it is a difficult scene. As such, these videos should be carefully commented on to obtain sophisticated data for system performance training and testing.

It is also advantageous to count/measure how many remarks have been made by which users and to consider this when selecting them, wherein users with fewer comments are given precedence, in particular. This guarantees that user reviews are evenly distributed among multiple people, which typically ensures better quality.

In a step 207, the information is used for adjusting or “retraining” the method based on machine learning.

As the training of the model can become very complex depending on the amount of data and the algorithm used, it is also possible to perform the training phase of the model on a processing unit with more computing/memory power, for example in a data center, and to then transfer the trained model obtained in this manner to another processing unit, such as a PC for video monitoring.

For the evaluation, the alarm events can then be entered as input values of the trained classifier, who then indicates an alarm event value and/or one of the predetermined classes, e.g., a true alarm or a false alarm, as output.

In all cases, it is possible for various steps described herein together or in a single unit to be performed at separate times or in separate places. The process module 11 may also be implemented in any manner, e.g., as a central control unit or a part thereof, as a control computer, via an external server, as a cloud service, or in some other manner.

It is also possible that alarm events or their data are stored at least temporarily and processed further at a later date or permanently stored for further analyses. It is to be understood that respective storage units may be at any location. Thus, any length of time may lie between when a video signal is recorded and when the further processing and evaluation steps are carried out; however, it is also possible for the signals to be processed and evaluated immediately.

In all cases, suitable user interfaces such as displays, screens, speakers, touch screens, or other output elements may also be used, for example, to display the results of the status evaluation, to depict intermediate steps for a user, to provide indications of error conditions, to display problems with the evaluation, or to output other information for a user. Input means may also be present, e.g. a keyboard and/or mouse, a touch screen, a microphone for voice input, or any other conventional input means via which, for example, method parameters can be selected or changed.

1. A method comprising:
obtaining (201), via a computer, a quantity of alarm events from a monitoring device (2),
determining (202), via the computer, an alarm event value for each alarm event of the quantity of alarm events via a method based on machine learning,
selecting (203), via the computer, an alarm event from the quantity of alarm events based on the alarm event value;
receiving (206), via the computer, at least one piece of information about the selected alarm event; and
adjusting (207), via the computer, the method based on machine learning using the received information.

2. The method according to claim 1, further comprising:
displaying (206) a user dialog for receiving the information for the selected alarm event.

3. The method of claim 2, wherein the user dialog for receiving the information for the selected alarm event is displayed (206) based on a duration of time that has elapsed since the last time the user dialog for receiving the information for another selected alarm event was displayed.

4. The method according to claim 1, comprising the following steps:
displaying (206) a user dialog for receiving the information for a non-selected alarm event in response to a user input.

5. The method of claim 2, wherein the user dialog comprises a quantity of predetermined information that can be selected by the user.

6. The method according to claim 1, comprising the following steps:
displaying (201) all alarm events with an alarm event value corresponding to a display criterion.

7. The method according to claim 1, comprising the following steps:
suppressing (201) the display of all alarm events with an alarm event value corresponding to a suppression criterion.

8. The method according to claim 1, wherein an alarm event is selected from the quantity of alarm events further based on at least one criterion, selected from a type of alarm event; a time of a review of the alarm event; a point in time at which the alarm event has occurred; a number of further alarm events occurring during a given period of time around the alarm event, an image/video quality; a review period.

9. The method of claim 1, wherein the information about the selected alarm event comprises a classification of the selected alarm event as an alarm or a false alarm.

10. A computing unit (11) configured to perform all method steps of a method according to claim 1.

11. A computer program that, when executed on a computing unit, causes the computing unit to perform all method steps of a method according to claim 1.

12. A non-transitory, computer-readable storage medium comprising instructions that when executed by a computer cause the computer to
obtain (201) a quantity of alarm events from a monitoring device (2),
determine (202) an alarm event value for each alarm event of the quantity of alarm events via a method based on machine learning.
select (203) an alarm event from the quantity of alarm events based on the alarm event value;
receive (206) at least one piece of information about the selected alarm event; and
adjust (207) the method based on machine learning using the received information.
